(19) United States
(12) Patent Application Publication
(10) Pub. No.: US 2015/0185574 A1
(43) Pub. Date: Jul. 2, 2015

(54) THIN-FILM TRANSISTOR LIQUID CRYSTAL DISPLAY DEVICE AND SIGNAL LINE THEREFOR

(71) Applicant: SHENZHEN CHINA STAR OPTOELECTRONICS TECHNOLOGY CO., LTD., Shenzhen (CN)

(72) Inventors: Bing Han, Shenzhen (CN); JinJie Wang, Shenzhen (CN)

(73) Assignee: SHENZHEN CHINA STAR OPTOELECTRONICS TECHNOLOGY CO., LTD., Shenzhen (CN)

(21) Appl. No.: 14/235,806

(22) PCT Filed: Jan. 7, 2014
(86) PCT No.: PCT/CN2014/070197

§ 371 Date: Jan. 29, 2014

(30) Foreign Application Priority Data
Dec. 30, 2013 (CN) 201310740141.2

(51) Int. Cl. G02F 1/1362

(52) U.S. Cl. CPC G02F 1/136286; G02F 2001/136295

(57) ABSTRACT

A thin-film transistor liquid crystal display device and a signal line therefor are disclosed. The signal line has a structure including a metal layer and a transparent electrical conductive layer stacked on the metal layer. The transparent electrical conductive layer is electrically connected to the metal layer. The multi-layered structure formed by the metal line and the transparent electrical conductive layer can effectively lower the resistance of the signal line, reduce the RC delay effect in electric circuits, and then further increase charging rate.

### BACKGROUND OF THE INVENTION

1. Field of the Invention

The present invention relates to a thin-film transistor liquid crystal device, and more particularly to a thin-film transistor liquid crystal display device that has low resistance signal lines, and to the structure of the signal lines.

2. Description of the Related Art

A thin-film transistor liquid crystal display (TFT-LCD) is a kind of display device that has become mainstream due to its advantages, such as low power consumption, light-weighted design, high resolution, etc.

Signal lines, such as scanning lines or data lines, which were wired on a pixel array substrate of the thin-film transistor liquid crystal display device usually have an RC delay problem that is caused by parasitic resistance and parasitic capacitance. For a small-sized liquid crystal display device, the influence of RC delay on the transmission speed on the signal lines can be ignored. However, with the size of liquid crystal display devices becoming larger and larger, the lengths of the signal lines on the pixel array substrate increase relatively, thereby leading to an increase in the resistance of the signal lines. Thus, the RC time delay problem will become much worse and greatly affect the transmission speed on the signal lines.

As for the scanning lines on the pixel array substrate, if the scanning lines have too much resistance, the electric signal transmitted thereon will be delayed, thereby resulting in a charging mistake, such as shown in FIG. 1; in the meantime, the delay will also cause uneven color shift in pixels.

With reference to FIG. 2, as for the data lines on the pixel array substrate, when the electric signal transitions between high and low potentials, the excessive resistance of the data lines will lessen the actual charging time, thereby limiting the rate of charging. Furthermore, as shown in FIG. 3, while displaying an image with mixed colors, the latter pixel will be charged by a signal that has a more perfect waveform compared with the former pixel under the influence of RC delay. And as a result, the charging difference between the latter and the former pixels induces color shift.

Hence, it is necessary to provide a new technical solution to overcome the problems existing in the conventional technology.

### SUMMARY OF THE INVENTION

In view of the shortcomings of conventional technology, the primary object of the present invention is to provide a thin-film transistor liquid crystal display device and a signal line therefor to solve the technical problem of poor charging rate due to the RC delay on the conventional signal lines.

In order to achieve the foregoing object, the present invention provides a signal line for a thin-film transistor liquid crystal display device, and the signal line has a structure including a metal layer, an insulating layer and a transparent electrical conductive layer. The insulating layer covers a top surface of the metal layer and has at least one through hole exposing the metal layer. The transparent electrical conductive layer is formed on the insulating layer and overlaps the metal layer, wherein the transparent electrical conductive layer is electrically connected to the metal layer via the through hole of the insulating layer.

The present invention further provides a thin-film transistor liquid crystal display device having a plurality of pixel areas arranged in a matrix, wherein the pixel areas are defined by a plurality of signal lines, and each of the signal lines has a structure including a metal layer, an insulating layer and a transparent electrical conductive layer. The insulating layer covers a top surface of the metal layer and has at least one through hole exposing the metal layer. The transparent electrical conductive layer is formed on the insulating layer and overlaps the metal layer, wherein the transparent electrical conductive layer is electrically connected to the metal layer via the through hole of the insulating layer.

The present invention is to form a transparent electrical conductive layer on a metal layer to form a signal line that is used to connect thin-film transistors. The multi-layered structure formed by the metal layer and the transparent electrical conductive layer can effectively lower the resistance of the signal line, reduce the RC delay effect, and then further increase charging rate and improve color shift.

### BRIEF DESCRIPTION OF THE DRAWINGS

FIG. 1 is a graph of the waveform of the signal transmitted through the scanning line of the conventional thin-film transistor liquid crystal display device;

FIG. 2 is a graph of the waveform of the signal transmitted through the data line of the conventional thin-film transistor liquid crystal display device;

FIG. 3 is a graph of the waveform of another signal transmitted through the data line of the conventional thin-film transistor liquid crystal display device;

FIG. 4 is a schematic view of the pixel array of the thin-film transistor liquid crystal display device according to a preferred embodiment of the present invention;

FIG. 5 is a schematic view of the signal lines that form the pixel areas according to a preferred embodiment of the present invention;

FIG. 6 is a cross-sectional view of the signal line according to a preferred embodiment of the present invention;

FIG. 7a is a graph of the waveform of the signal transmitted through the data line of the thin-film transistor liquid crystal display device according to the preferred embodiment of the present invention;

FIG. 7b is a graph of the waveform of the signal transmitted through the data line of the thin-film transistor liquid crystal display device according to another preferred embodiment of the present invention; and

FIG. 8 is a cross-sectional view of the signal line according to another preferred embodiment of the present invention.

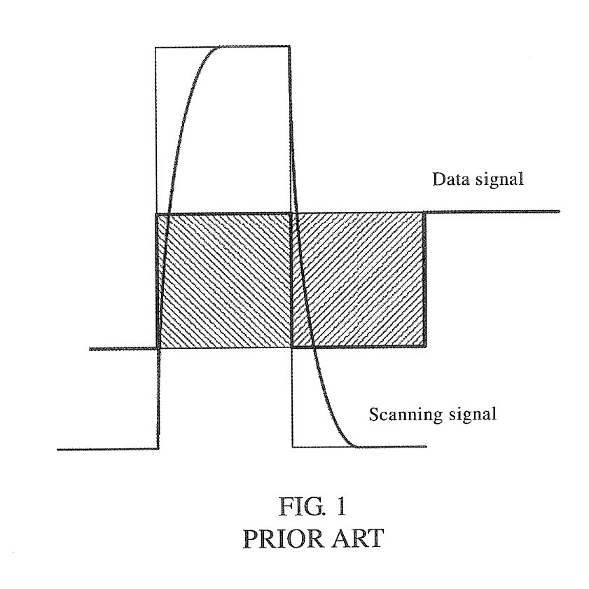

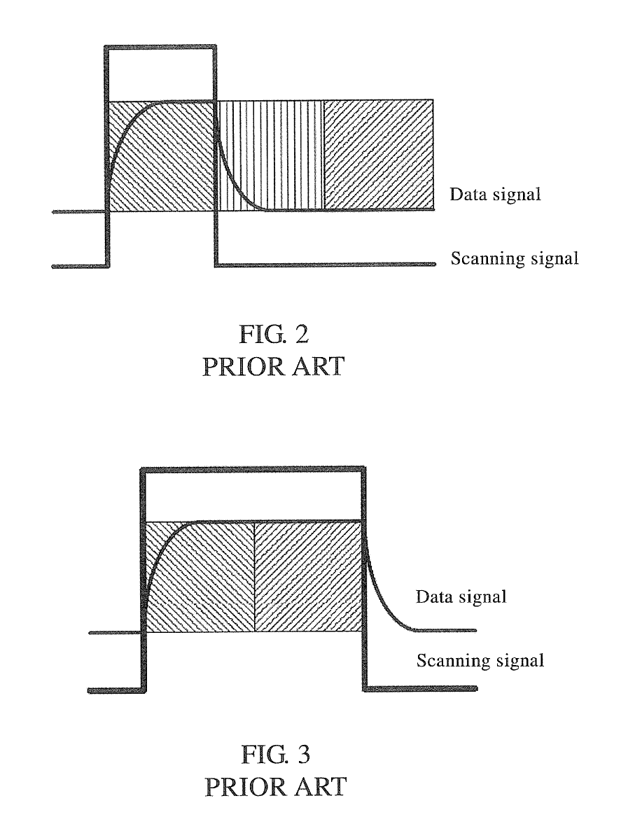

### DETAILED DESCRIPTION OF THE PREFERRED EMBODIMENTS

The following description of each embodiment is referring to the accompanying drawings so as to illustrate practicable specific embodiments in accordance with the present invention. The directional terms described in the present invention, such as upper, lower, front, rear, left, right, inner, outer, side, etc., are only directions referring to the accompanying drawings, so that the used directional terms are used to describe and understand the present invention, but the present invention is not limited thereto.

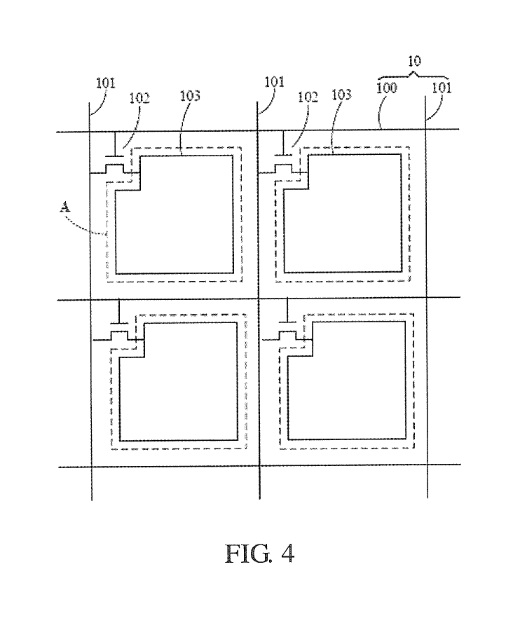

With reference to FIG. 4, FIG. 4 is a schematic view of a pixel array of a thin-film transistor liquid crystal display device according to a preferred embodiment of the present invention. The thin-film transistor liquid crystal display device basically includes two substrates which are mounted opposite each other, and a liquid crystal layer which is mounted between the substrates. As shown in FIG. 4, one of the substrates is provided with a plurality of signal lines 10 that are formed thereon and include a plurality of scanning lines 100 and a plurality of data lines 101. The scanning lines 100 extend in a transverse direction and are arranged side by side at intervals. The data lines 101 extend in a longitudinal direction, and are arranged side by side at intervals, and vertically cross the scanning lines 100, thereby defining a plurality of pixel areas A arranged in a matrix. Each of the pixel areas A is provided with a thin-film transistor 102 which is simultaneously connected to one of the scanning lines 100, one of the data lines 101, and a pixel electrode 103. The thin-film transistor 102 can receive a scanning signal from the scanning line 100 to be switched on so that a data signal on the data line 101 can be transmitted to the pixel electrode 103 via the thin-film transistor 102.

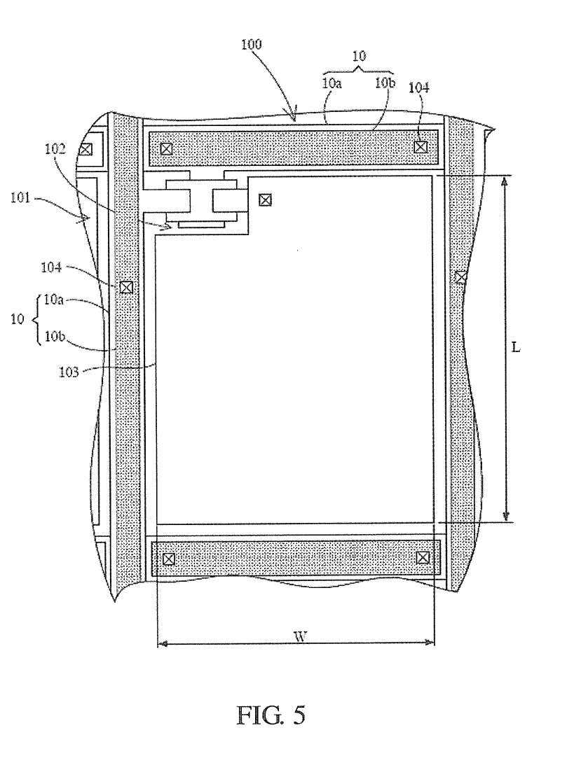

With further reference to FIGS. 5 and 6, at least one kind of signal line 10 that defines the pixel areas A, which means the scanning line 100 or the data line 101, has a multi-layered structure. The multi-layered structure mainly includes a metal layer 10a and a transparent electrical conductive layer 10b which is stacked on and electrically connected to the metal layer 10a.

The metal layer 10a can be formed on the surface of a glass substrate by performing sputtering and etching processes, and is preferably a copper layer.

The transparent electrical conductive layer 10b may be directly or indirectly formed on a top surface of the metal layer 10a correspondingly. For example, in the present embodiment, an insulating layer 10c is formed between the metal layer 10a and the transparent electrical conductive layer 10b, wherein the insulating layer 10c covers the top surface of the metal layer 10a and has at least one through hole 104 that partially exposes the metal layer 10a. The transparent electrical conductive layer 10b is formed on the insulating layer 10 and overlaps the metal layer 10a, and is electrically connected to the metal layer 10a via the through hole 104 of the insulating layer 10c.

In the present embodiment, the insulating layer 10c includes a plurality of through holes 104 that are arranged at intervals. As shown in FIG. 5, the through holes 104 are arranged at intervals along a length direction of the signal line 10. In more detail, when the signal line 10 is used as the scanning line 100, the signal line 10 preferably has two of the through holes 104 within the width W of each pixel area A. In other words, the scanning line 100 has a section ranging within the width of the pixel area A, and in the section there are two through holes 104. In this embodiment, the two through holes 104 may be away from each other, and be close to two sides of the pixel area, respectively. The arrangement of the through holes 104 can effectively enhance the electrical connection between the transparent electrical conductive layer 10b and the metal layer 10a.

That the transparent electrical conductive layer 10b is overlapping and connected to the metal layer 10a can effectively lower the resistance of the signal line 10. When the signal line 10 is used as the scanning line 100 to transmit a scanning signal, the RC delay effect can be reduced so that the charging-mistake situation can be improved and the charging rate of pixel electrodes can be raised.

When the signal line 10 is used as the data line 101, within the length L of each of the pixel area A, the signal line 10 preferably has one of the through holes 104; in other words, the data line 101 has a section ranging within the length of the pixel area A, and in the section there is one through hole 104.

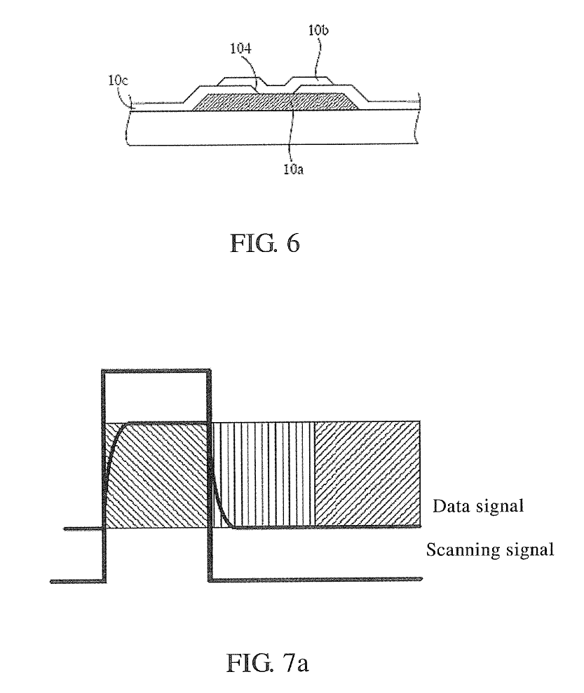

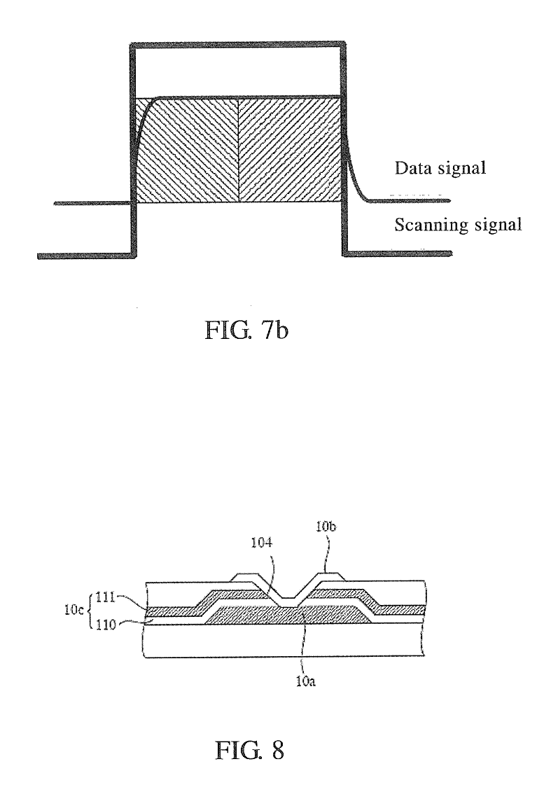

Since that the transparent electrical conductive layer 10b is overlapping and connected to the metal layer 10a can effectively lower the resistance of the signal line 10, when the signal line 10 is used as the data line 101 to transmit a data signal, as shown in FIG. 7a, the RC delay effect is reduced, and then the charging rate of the pixel electrodes is effectively increased. In the meantime, as shown in FIG. 7b, when two adjacent pixels perform color mixing, the charging difference between the pixels is decreased due to the reduction of the RC delay effect so that the color shift problem is also improved.

With further reference to FIG. 8, FIG. 8 is a cross-sectional view of the signal line according to another preferred embodiment of the present invention. In this embodiment, the thin-film transistor liquid crystal display device further has a color filtering layer that is mounted on the pixel array constituted by the pixel areas, which can economize on the amount of material used, compared with the conventional way of mounting a color filtering layer on anther substrate. Thus, in this embodiment, the insulating layer 10c includes at least one transparent layer 110 and a color filtering layer 111 that is formed by photoresists.

In conclusion, compared with the conventional thin-film transistor liquid crystal display device that has a serious RC delay problem, the present invention that forms a signal line, which is used to connect thin-film transistors, by disposing a transparent electrical conductive layer on the top of a metal line with the connection using through holes, can effectively lower the overall resistance of the signal line due to the multi-layered structure constituted by the metal layer and the transparent electrical conductive layer. Thus, the RC delay effect is reduced and then the charging rate of pixel electrodes is raised and the color shift problem is improved.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A signal line for a thin-film transistor liquid crystal display device, wherein the thin-film transistor liquid crystal display device has a plurality of scanning lines being arranged side by side at intervals, and a plurality of data lines being arranged side by side at intervals and vertically crossing the scanning lines; the scanning lines and the data lines define a plurality of pixel areas arranged in a matrix; a plurality of the signal lines are used as the scanning lines and the data lines, and each of the signal lines has a structure comprising:
a metal layer;
an insulating layer covering a top surface of the metal layer and having at least one through hole exposing the metal layer; and
a transparent electrical conductive layer formed on the insulating layer and overlapping the metal layer, wherein the transparent electrical conductive layer is electrically connected to the metal layer via the through hole of the insulating layer.

2. The signal line for the thin-film transistor liquid crystal display device as claimed in claim 1, wherein the insulating layer has a plurality of the through holes arranged at intervals; the through holes are arranged along a length direction of the signal line; and within the width of each of the pixel areas, each of the signal lines that are used as the scanning lines is provided with two of the through holes.

3. The signal line for the thin-film transistor liquid crystal display device as claimed in claim 2, wherein within the length of each of the pixel areas, each of the signal lines that are used as the data lines is provided with one of the through holes.

4. A signal line for a thin-film transistor liquid crystal display device comprising:
a metal layer;
an insulating layer covering a top surface of the metal layer and having at least one through hole exposing the metal layer; and
a transparent electrical conductive layer formed on the insulating layer and overlapping the metal layer, wherein the transparent electrical conductive layer is electrically connected to the metal layer via the through hole of the insulating layer.

5. The signal line for the thin-film transistor liquid crystal display device as claimed in claim 4, wherein the thin-film transistor liquid crystal display device has a plurality of scanning lines being arranged side by side at intervals, and a plurality of data lines being arranged side by side at intervals and vertically crossing the scanning lines; the scanning lines and the data lines define a plurality of pixel areas arranged in a matrix; and a plurality of the signal lines are used as the scanning lines of the thin-film transistor liquid crystal display device.

6. The signal line for the thin-film transistor liquid crystal display device as claimed in claim 5, wherein the insulating layer has a plurality of the through holes arranged at intervals; the through holes are arranged along a length direction of the signal line; and within the width of each of the pixel areas, each of the signal lines that are used as the scanning lines is provided with two of the through holes.

7. The signal line for the thin-film transistor liquid crystal display device as claimed in claim 4, wherein the thin-film transistor liquid crystal display device has a plurality of scanning lines being arranged side by side at intervals, and a plurality of data lines being arranged side by side at intervals and vertically crossing the scanning lines; the scanning lines and the data lines define a plurality of pixel areas arranged in a matrix; and a plurality of the signal lines are used as the data lines of the thin-film transistor liquid crystal display device.

8. The signal line for the thin-film transistor liquid crystal display device as claimed in claim 7, wherein the insulating layer has a plurality of the through holes arranged at intervals; the through holes are arranged along a length direction of the signal line; and within the length of each of the pixel areas, each of the signal lines that are used as the data lines is provided with one of the through holes.

9. The signal line for the thin-film transistor liquid crystal display device as claimed in claim 5, wherein the insulating layer includes at least one transparent layer and a color filtering layer.

10. A thin-film transistor liquid crystal display device comprising a plurality of pixel areas arranged in a matrix, wherein the pixel areas are defined by a plurality of signal lines, and each of the signal lines has a structure comprising:
a metal layer;
an insulating layer covering a top surface of the metal layer and having at least one through hole exposing the metal layer; and
a transparent electrical conductive layer formed on the insulating layer and overlapping the metal layer, wherein the transparent electrical conductive layer is electrically connected to the metal layer via the through hole of the insulating layer

11. The thin-film transistor liquid crystal display device as claimed in claim 10, wherein the signal lines includes a plurality of scanning lines being arranged side by side at intervals, and a plurality of data lines being arranged side by side at intervals and vertically crossing the scanning lines.

12. The thin-film transistor liquid crystal display device as claimed in claim 10, wherein the insulating layer has a plurality of the through holes arranged at intervals; the through holes are arranged along a length direction of the signal line.

13. The thin-film transistor liquid crystal display device as claimed in claim 11, wherein within the width of each of the pixel areas, each of the signal lines that are used as the scanning lines is provided with two of the through holes; and within the length of each of the pixel areas, each of the signal lines that are used as the data lines is provided with one of the through holes.
